(19) United States
(12) Patent Application Publication
(10) Pub. No.: US 2026/0213387 A1
(43) Pub. Date: Jul. 23, 2026

(54) BATTERY CELL ASSEMBLY

(71) Applicant: LG ENERGY SOLUTION, LTD., Seoul (KR)

(72) Inventor: Dong-Min KANG, Daejeon (KR)

(73) Assignee: LG ENERGY SOLUTION, LTD., Seoul (KR)

(21) Appl. No.: 19/139,169

(22) PCT Filed: Jul. 12, 2024
(86) PCT No.: PCT/KR2024/009999

§ 371 Date: Jun. 13, 2025

(30) Foreign Application Priority Data
Jul. 12, 2023 (KR) 10-2023-0090629

(51) Int. Cl. H01M 50/682; A62C 3/06; A62C 3/16; H01M 50/105; H01M 50/116; H01M 50/178; H01M 50/186; H01M 50/202; H01M 50/211; H01M 50/22; H01M 50/249

(52) U.S. Cl. CPC H01M 50/682; A62C 3/06; A62C 3/16; H01M 50/105; H01M 50/116; H01M 50/178; H01M 50/186; H01M 50/202; H01M 50/211; H01M 50/22; H01M 50/249

(57) ABSTRACT

A battery cell assembly may include a battery cell including an electrode assembly and a first case configured to surround the electrode assembly, a second case configured to cover at least a portion of the first case, and an extinguishing agent configured to fill a space between the first case and the second case.

### DESCRIPTION

### Technical Field

The present disclosure relates to a battery cell assembly.

The present application claims priority to Korean Patent Application No. 10-2023-0090629 filed on Jul. 12, 2023 in the Republic of Korea, the disclosures of which are incorporated herein by reference.

### Background Art

As the demand for portable electronic products such as laptops, video cameras, mobile phones, and the like rapidly increases, and as robots, electric vehicles, and the like are progressively commercialized, active researches on high-performance secondary batteries capable of being repeatedly charged and discharged are underway.

Currently commercialized secondary batteries include nickel-cadmium batteries, nickel-hydrogen batteries, nickel-zinc batteries, and lithium secondary batteries. Among them, lithium secondary batteries are in the spotlight for their advantages of free charging and discharging due to almost no memory effect, a very low self-discharge rate, and a high energy density, compared to nickel-based secondary batteries.

These lithium secondary batteries generally use lithium-based oxides and carbon materials as positive and negative electrode active materials, respectively. The lithium secondary batteries include an electrode assembly in which positive and negative electrode plates, coated with the positive and negative electrode active materials, respectively, are disposed with a separator therebetween and an exterior case, i.e., a battery case, that stores and seals the electrode assembly with an electrolyte.

In general, lithium secondary batteries may be classified, depending on the shape of the exterior case, into can-type secondary batteries in which the electrode assembly is accommodated in a metal can and pouch-type secondary batteries in which the electrode assembly is accommodated in a pouch of an aluminum laminate sheet.

Recently, secondary batteries have been widely used in medium and large devices for driving or energy storage, such as electric vehicles and energy storage systems (ESSs), as well as in small devices such as portable electronic devices. A plurality of secondary batteries described above may be electrically connected and stored inside a module case to form one battery module. In addition, multiple battery modules described above may be connected to configure one battery pack.

However, in the case where a large number of secondary batteries (battery cells) or a large number of battery modules are densely stored in a small space, they may be vulnerable to a thermal event. In particular, if an event such as thermal runaway occurs in any one battery cell, high-temperature gas, flame, and heat may be generated. If such gas, flame, or heat transfers to other battery cells included in the same battery module, an explosive chain reaction such as thermal propagation may occur. In addition, this chain reaction may cause accidents such as fire or explosion in other battery modules, as well as in the relevant battery module.

Moreover, since medium and large battery packs used in electric vehicles include a large number of battery cells and battery modules to increase output and/or capacity, the risk of a thermal chain reaction may be further increased. In addition, in the case of a battery pack mounted to an electric vehicle or the like, there may be users such as drivers nearby. Accordingly, if a thermal event occurring in a specific battery module fails to be controlled to lead to a chain reaction, it may cause significant property damage and casualties.

Therefore, when a thermal event occurs in a battery cell, immediate measures such as supply of an extinguishing agent are required.

### DISCLOSURE

### Technical Problem

The present disclosure aims to solve the problems described above and other problems.

The present disclosure also aims to provide a battery cell assembly capable of immediately supplying an extinguishing agent when a thermal event occurs.

The present disclosure also aims to provide a battery cell assembly capable of maintaining energy density while providing an extinguishing agent.

### Technical Solution

According to one aspect of the present disclosure, there may be provided a battery cell assembly. The battery cell assembly may include a battery cell including an electrode assembly and a first case configured to surround the electrode assembly, a second case configured to cover at least a portion of the first case, and an extinguishing agent configured to fill a space between the first case and the second case.

In addition, the second case may include an electrically insulating material.

In addition, the second case may include a same material as a material of the first case.

In addition, the second case may be spaced apart from at least one surface of the first case to form a gap, and the gap may be configured to be filled with the extinguishing agent.

In addition, the battery cell may further include an electrode lead configured to protrude from the electrode assembly, and the first case may include a terrace portion configured to surround the electrode lead, and the second case may be spaced apart from the terrace portion to form a gap, and the gap may be configured to be filled with the extinguishing agent.

In addition, the battery cell assembly may further include an insulating member positioned between the electrode lead and the terrace portion and configured to surround the electrode lead.

In addition, the insulating member may extend to be exposed to an outside of the terrace portion.

In addition, the insulating member may extend to be exposed to an outside of the second case.

In addition, the first case may include a first part configured to cover a first side of the electrode assembly, and a second part configured to cover a second side of the electrode assembly, the second part being bonded to the first part, and the second case may extend to cover a portion where the first part and the second part are bonded.

In addition, the extinguishing agent may be configured to surround the portion where the first part and the second part are bonded.

In addition, the extinguishing agent may include Novec 1230.

A battery module according to one aspect of the present disclosure may include the battery cell assembly of the present disclosure.

A battery pack according to one aspect of the present disclosure may include the battery cell assembly of the present disclosure.

A vehicle according to one aspect of the present disclosure may include the battery cell assembly of the present disclosure.

### Advantageous Effects

According to at least one of the embodiments of the present disclosure, when a thermal event occurs in a battery cell assembly, it is possible to immediately supply an extinguishing agent, thereby improving thermal safety.

According to at least one of the embodiments of the present disclosure, it is possible to maintain energy density while improving thermal safety.

### DESCRIPTION OF DRAWINGS

The accompanying drawings illustrate embodiments of the present disclosure and, together with the detailed description of the invention, serve to provide further understanding of the technical idea of the present disclosure, and thus, the present disclosure is not construed as being limited to the drawings.

FIG. 1 is a perspective view illustrating a battery cell assembly according to an embodiment of the present disclosure.

FIG. 2 is a drawing illustrating a manufacturing process of a battery cell assembly according to an embodiment of the present disclosure.

FIG. 3 is a perspective view illustrating the internal configuration of a battery cell assembly according to an embodiment of the present disclosure.

FIG. 4 is a cross-sectional view schematically illustrating the configuration taken along line A-A′ in FIG. 1.

FIG. 5 is a drawing illustrating a situation in which a thermal event occurred in FIG. 4.

FIG. 6 is a cross-sectional view schematically illustrating the configuration taken along line B-B′ in FIG. 1.

FIG. 7 is a drawing illustrating a situation in which a thermal event occurred in FIG. 6.

FIG. 8 is a cross-sectional view schematically illustrating battery cell assemblies stacked according to an embodiment of the present disclosure.

FIG. 9 is a drawing illustrating a situation in which a thermal event occurred in FIG. 8.

FIG. 10 is a drawing illustrating the coupling of an electrode assembly and a first case of a battery cell assembly according to another embodiment of the present disclosure.

FIG. 11 is a drawing illustrating a battery cell of a battery cell assembly according to another embodiment of the present disclosure.

FIG. 12 is a drawing illustrating a battery cell assembly according to another embodiment of the present disclosure.

FIG. 13 is a drawing illustrating the battery cell assemblies of FIG. 12 stacked.

FIG. 14 is a cross-sectional view schematically illustrating the configuration taken along line C-C′ in FIG. 13.

FIG. 15 is a cross-sectional view schematically illustrating the configuration taken along line D-D′ in FIG. 13.

FIG. 16 is a drawing illustrating the coupling of an electrode assembly and a first case of a battery cell assembly according to another embodiment of the present disclosure.

FIG. 17 is a drawing illustrating a battery cell of a battery cell assembly according to another embodiment of the present disclosure.

FIG. 18 is a drawing illustrating a battery cell assembly according to another embodiment of the present disclosure.

FIG. 19 is a drawing illustrating the coupling of an electrode assembly and a first case of a battery cell assembly according to another embodiment of the present disclosure.

FIG. 20 is a drawing illustrating a battery cell of a battery cell assembly according to another embodiment of the present disclosure.

FIG. 21 is a drawing illustrating a battery cell assembly according to another embodiment of the present disclosure.

### BEST MODE

Hereinafter, embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the configurations proposed in the embodiments and drawings of this specification indicate only some embodiment of the present disclosure and do not represent all technical ideas of the present disclosure, so it should be understood that various equivalents and modifications could be made thereto at the time of filing the application.

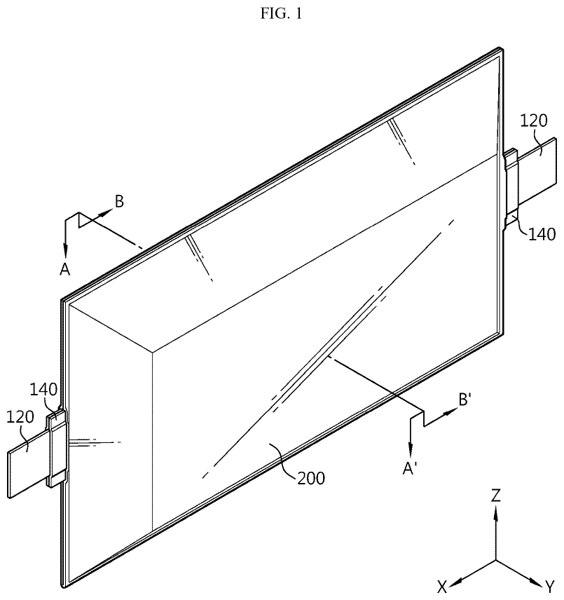

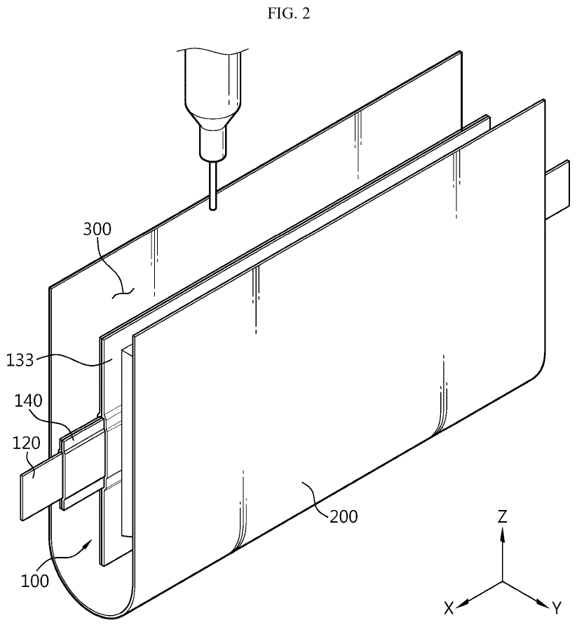

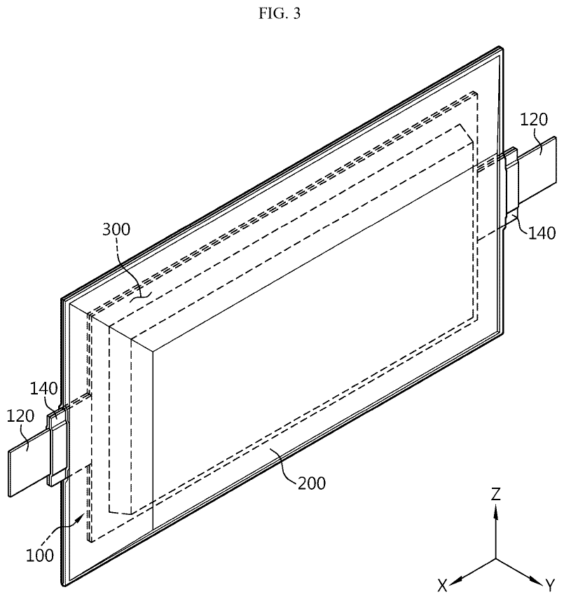

FIG. 1 is a perspective view illustrating a battery cell assembly according to an embodiment of the present disclosure. FIG. 2 is a drawing illustrating a manufacturing process of a battery cell assembly according to an embodiment of the present disclosure. FIG. 3 is a perspective view illustrating the internal configuration of a battery cell assembly according to an embodiment of the present disclosure. Referring to FIGS. 1 to 3, a battery cell assembly according to an embodiment of the present disclosure may include a battery cell 100, a second case 200, and an extinguishing agent 300.

The battery cell 100 may have a pouch shape or a cuboid shape. In this case, the battery cell 100 may indicate a secondary battery. The battery cell 100 may include an electrode assembly 110 and a first case 130 that surrounds the electrode assembly 110. The first case 130 may seal the electrode assembly 110. In addition, the first case 130 may insulate the electrode assembly 110.

The second case 200 may cover at least a portion of the first case 130. In addition, the second case 200 may be at least partially attached, coupled, or fixed to the first case 130.

A space between the first case 130 and the second case 200 may be filled with the extinguishing agent 300. The second case 200 may accommodate, store, or seal the extinguishing agent 300. For example, the extinguishing agent 300 may be in a liquid state.

According to this configuration of the present disclosure, when a thermal event occurs from the battery cell 100, immediate extinguishment may be attained. When a thermal event occurs, ignitable particles s, such as venting gas g and spark s, may melt the first case 130 and may be discharged to the outside of the battery cell 100. In this case, the extinguishing agent 300 provided between the first case 130 and the second case 200 may be immediately supplied to the portion where the thermal event occurred. Therefore, extinguishment may be immediately performed without electronic control or physical control, thereby improving the thermal safety of the battery cell assembly.

Referring to FIGS. 1 to 3, the extinguishing agent 300 of the battery cell assembly according to an embodiment of the present disclosure may be configured as Novec 1230.

According to this configuration of the present disclosure, the extinguishing agent 300 may be configured in a liquid state and may be electrically non-conductive. In addition, the extinguishing agent 300 may quickly absorb heat and effectively suppress the propagation of the thermal event.

Referring to FIGS. 1 to 3, the second case 200 of the battery cell assembly according to an embodiment of the present disclosure may be configured as an electrically insulating material.

According to this configuration of the present disclosure, even if a thermal event occurs, the extinguishing agent 300 and the second case 200 may block current leakage from the battery cell 100. Therefore, the thermal safety and electrical safety of the battery cell assembly may be improved.

Referring to FIGS. 1 to 3, the second case 200 of the battery cell assembly according to an embodiment of the present disclosure may be configured as the same material as the first case 130.

According to this configuration of the present disclosure, if heat is generated due to a thermal event so as to melt the first case 130, the second case 200 may also melt. For example, in the case where a plurality of battery cell assemblies are stacked, if a thermal event occurs from one of the battery cell assemblies to cause venting gas g or ignitable particles s to emit, the second case 200 of the adjacent battery cell assembly may melt to cause the extinguishing agent 300 provided in the adjacent battery cell assembly to leak out, thereby suppressing the thermal event.

Referring to FIGS. 1 to 3, the second case 200 of the battery cell assembly according to an embodiment of the present disclosure may be spaced apart from at least one surface of the first case 130 to form a gap therebetween, and the gap may be filled with the extinguishing agent 300.

At least a portion of the second case 200 may be spaced apart from the first case 130. In addition, at least a portion of the second case 200 may be coupled, attached, or fixed to the first case 130. The second case 200 may be spaced apart from a plurality of surfaces of the first case 130 to form gaps.

According to this configuration of the present disclosure, the extinguishing agent 300 may be disposed to surround the battery cell 100. The extinguishing agent 300 may be immediately supplied even if a thermal event occurs in any part of the battery cell 100. This may improve the thermal safety of the battery cell assembly.

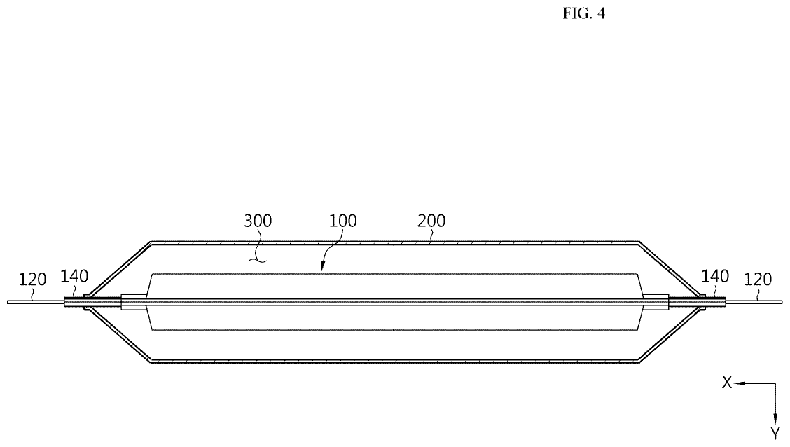

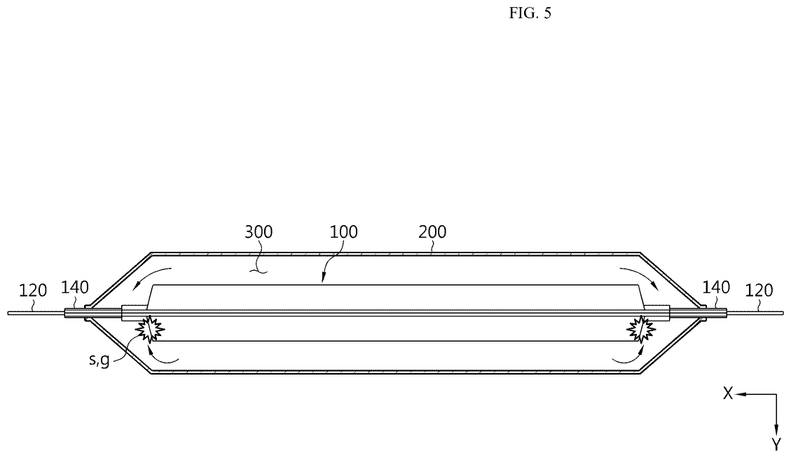

FIG. 4 is a cross-sectional view schematically illustrating the configuration taken along line A-A′ in FIG. 1. FIG. 5 is a drawing illustrating a situation in which a thermal event occurred in FIG. 4. Referring to FIGS. 4 and 5, the battery cell 100 of the battery cell assembly according to an embodiment of the present disclosure may further include an electrode lead 120 protruding from an electrode assembly 110, and the first case 130 may include a terrace portion 133 surrounding the electrode lead 120, and the second case 200 may be spaced apart from the terrace portion 133 to form a gap. In addition, the gap may be filled with an extinguishing agent 300.

According to this configuration of the present disclosure, if a thermal event occurs so that the terrace portion 133 melts and venting gas g or ignitable particles s emit, the extinguishing agent 300 may be immediately supplied to the portion where the terrace portion 133 melts.

Referring to FIGS. 4 and 5, the battery cell assembly according to an embodiment of the present disclosure may further include an insulating member 140 positioned between the electrode lead 120 and the terrace portion 133 and surrounding the electrode lead 120. The insulating member 140 may be electrically insulating. The insulating member 140 may insulate the electrode lead 120 and the terrace portion 133 from each other. In addition, the insulating member 140 may be configured to surround the electrode lead 120. The insulating member 140 may electrically insulate the electrode lead 120 and the second case 200 from each other. The insulating member 140 may be attached, coupled, deposited, or coated on the electrode lead 120.

According to this configuration of the present disclosure, the second case 200 may be electrically stable even if it is coupled, attached, or fixed to the first case 130 or the terrace portion 133.

Referring to FIGS. 4 and 5, the insulating member 140 of the battery cell assembly according to an embodiment of the present disclosure may extend to be exposed to the outside of the terrace portion 133.

The insulating member 140 may protrude to be exposed to the outside of the terrace portion 133 along with the electrode lead 120. In this case, the second case 200 may be coupled, attached, or fixed to the insulating member 140.

According to this configuration of the present disclosure, the second case 200 may be electrically insulated from the electrode lead 120 while surrounding the entire terrace portion 133. As a result, the electrical safety of the battery cell assembly may be improved.

Referring to FIGS. 4 and 5, the insulating member 140 of the battery cell assembly according to an embodiment of the present disclosure may extend to be exposed to the outside of the second case 200.

According to this configuration of the present disclosure, the second case 200 and the electrode lead 120 may be physically separated from each other. As a result, the second case 200 and the electrode lead 120 may be electrically insulated more reliably.

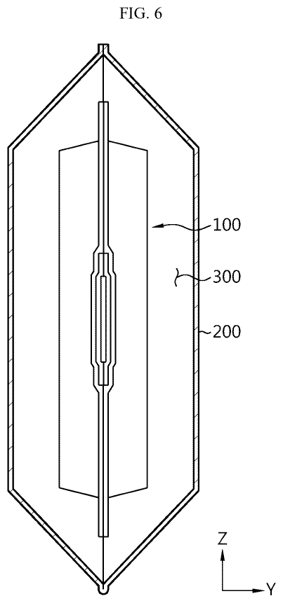

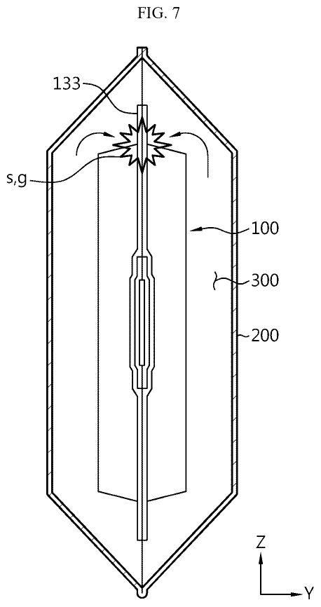

FIG. 6 is a cross-sectional view schematically illustrating the configuration taken along line B-B′ in FIG. 1. FIG. 7 is a drawing illustrating a situation in which a thermal event occurred in FIG. 6. Referring to FIG. 6 and FIG. 7, the second case 200 of the battery cell assembly according to an embodiment of the present disclosure may be configured to surround all of the upper surface, lower surface, and side surface of the battery cell 100. Therefore, the battery cell 100 may be entirely surrounded by the extinguishing agent 300.

In this case, the terrace portion 133 may be formed on at least one of the upper surface or lower surface of the battery cell 100. The second case 200 may be spaced apart from the terrace portion 133 to form a gap. In addition, the gap may be filled with the extinguishing agent 300.

According to this configuration of the present disclosure, if a thermal event occurs so that the terrace portion 133 melts and venting gas g or ignitable particles s emit, the extinguishing agent 300 may be immediately supplied to the portion where the terrace portion 133 melts.

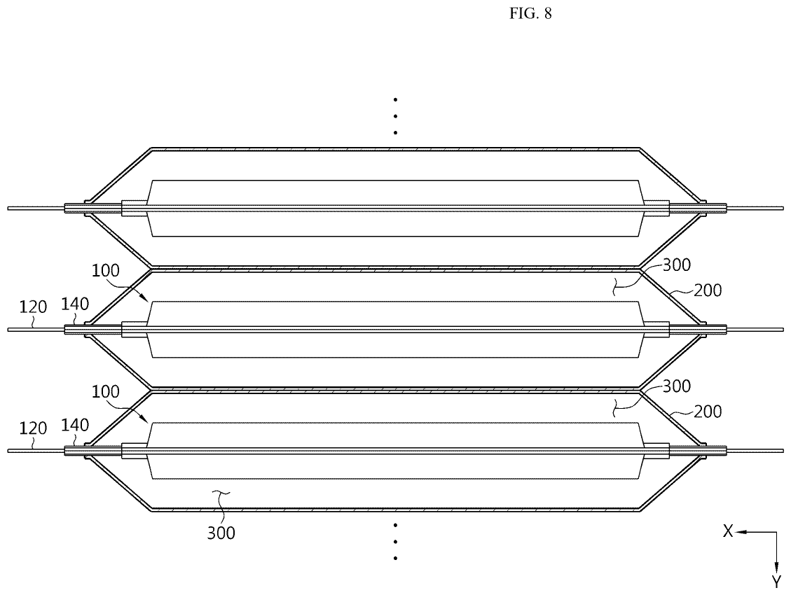

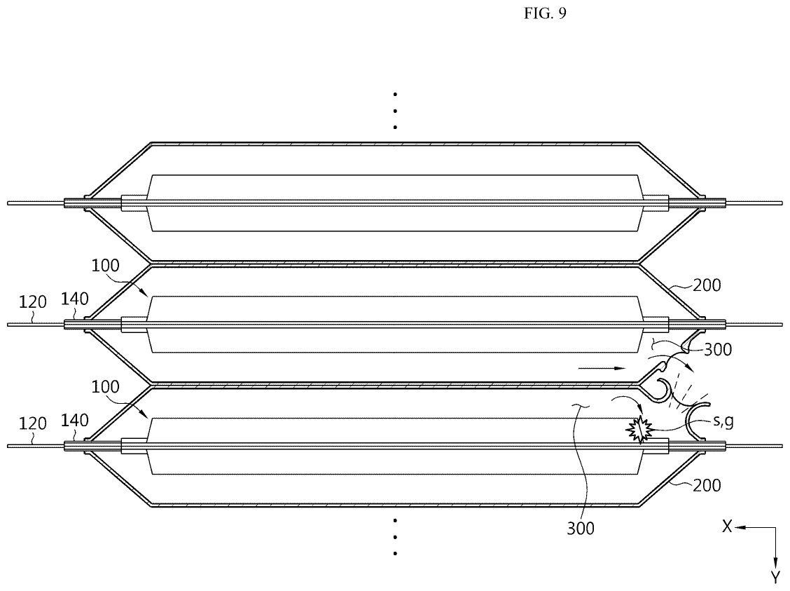

FIG. 8 is a cross-sectional view schematically illustrating battery cell assemblies stacked according to an embodiment of the present disclosure. FIG. 9 is a drawing illustrating a situation in which a thermal event occurred in FIG. 8. Referring to FIGS. 8 and 9, a plurality of battery cell assemblies according to an embodiment of the present disclosure may be provided, and the plurality of battery cell assemblies may be stacked on each other. The plurality of stacked battery cell assemblies may be accommodated or mounted in a structure such as a case of a battery module or a case of a battery pack.

In this case, the plurality of battery cell assemblies may be stacked so as to be in contact with each other. In addition, when a thermal event occurs from one of the battery cell assemblies, the emitted venting gas g or ignitable particles s may melt the second case 200 of an adjacent battery cell assembly. As a result, the extinguishing agent 300 in the adjacent battery cell assembly may leak out, thereby suppressing the propagation of the thermal event.

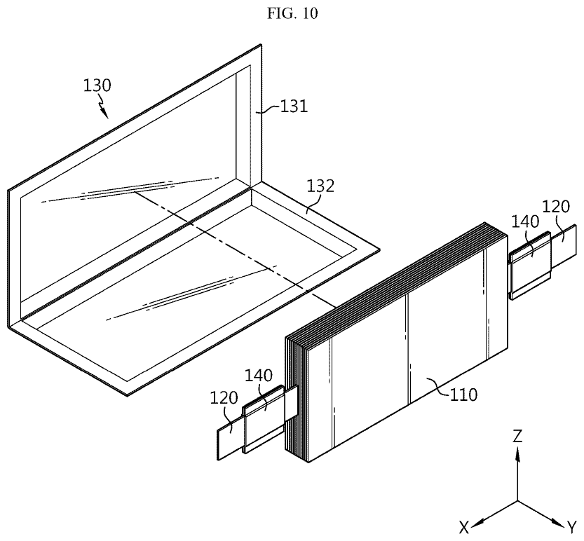

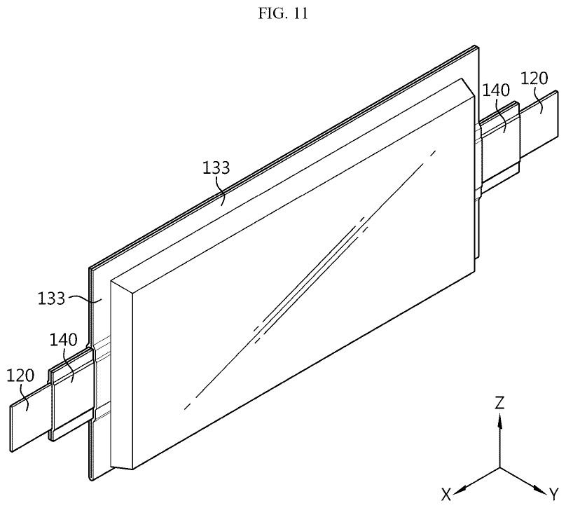

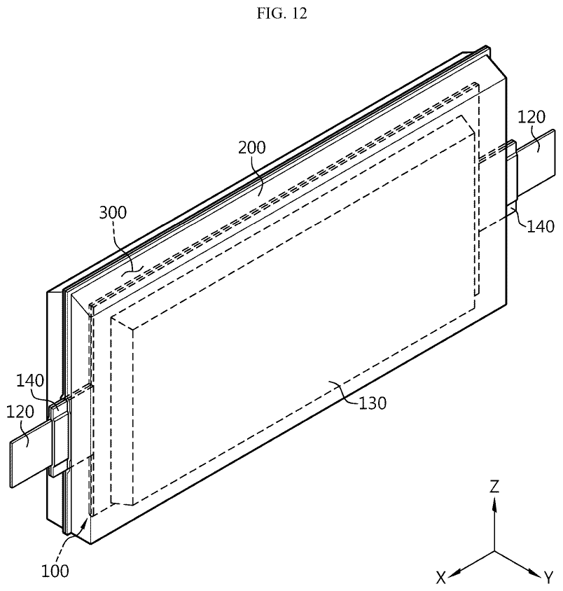

FIG. 10 is a drawing illustrating the coupling of an electrode assembly and a first case of a battery cell assembly according to another embodiment of the present disclosure. FIG. 11 is a drawing illustrating a battery cell of a battery cell assembly according to another embodiment of the present disclosure. FIG. 12 is a drawing illustrating a battery cell assembly according to another embodiment of the present disclosure.

Referring to FIGS. 10 to 12, a first case 130 of a battery cell assembly according to another embodiment of the present disclosure may include a first part 131 covering one side of the electrode assembly 110 and a second part 132 covering the other side of the electrode assembly 110 and bonded to the first part 131. In addition, the second case 200 may extend to cover a portion where the first part 131 and the second part 132 are bonded. The first case 130 may form the first part 131 and the second part 132 by folding one member thereof. Therefore, a terrace portion 133 of the battery cell 100 may be formed on three surfaces along the front surface, upper surface, and back surface of the battery cell 100. In addition, the second case 200 may form a gap along the terrace portion 133 of the battery cell 100, and the gap may be filled with an extinguishing agent 300. That is, the extinguishing agent 300 may be disposed along the front surface, upper surface, and back surface of the battery cell 100. Alternatively, the extinguishing agent 300 may be filled to surround a portion where the first part 131 and the second part 132 are bonded. The second case 200 may be attached, coupled, or fixed to the side of the battery cell 100 or the first case 130.

According to this configuration of the present disclosure, the space occupied by the extinguishing agent 300 may be reduced. In addition, the extinguishing agent 300 may not be positioned on both sides of the battery cell assembly. This may increase the energy density when the battery cell assemblies are stacked in the left-right direction or the Y-axis direction.

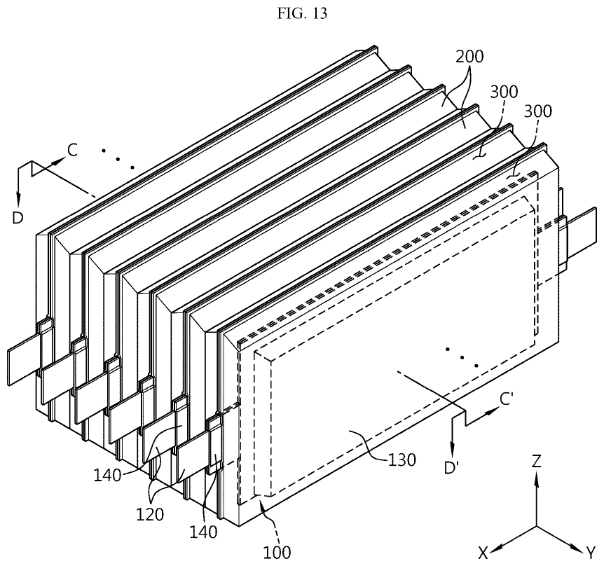

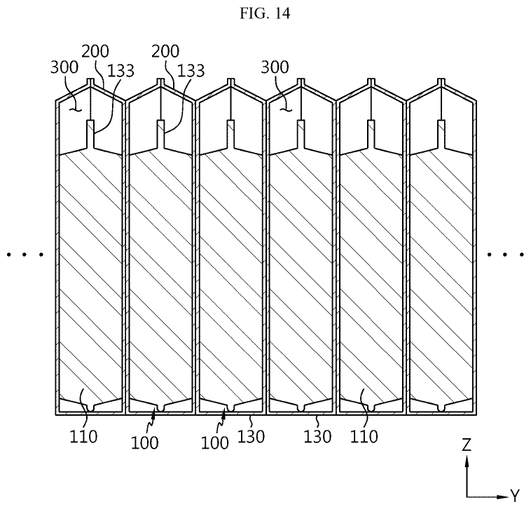

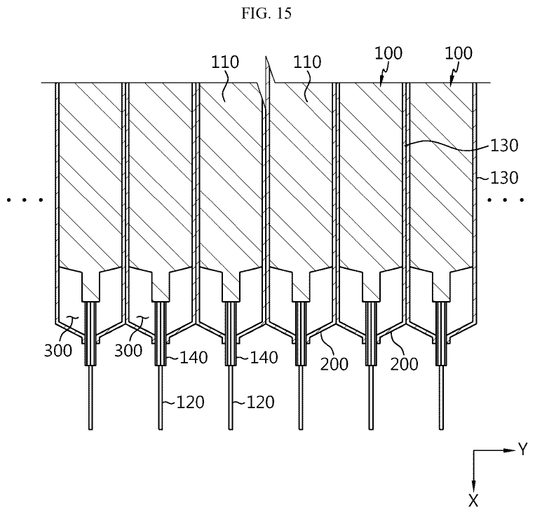

FIG. 13 is a drawing illustrating the battery cell assemblies of FIG. 12 stacked. FIG. 14 is a cross-sectional view schematically illustrating the configuration taken along line C-C′ in FIG. 13. FIG. 15 is a cross-sectional view schematically illustrating the configuration taken along line D-D′ in FIG. 13.

Referring to FIGS. 13 to 15, battery cell assemblies according to another embodiment of the present disclosure may be stacked in the left-right direction or the Y-axis direction. In this case, the battery cells 100 of the plurality of battery cell assemblies may be disposed to be close to each other or may come into contact with each other in the left-right direction or the Y-axis direction. The extinguishing agents 300 provided in the respective battery cell assemblies may be arranged in the left-right direction or the Y-axis direction.

According to this configuration of the present disclosure, when the plurality of battery cell assemblies are stacked, the energy density may be maintained while improving the thermal safety.

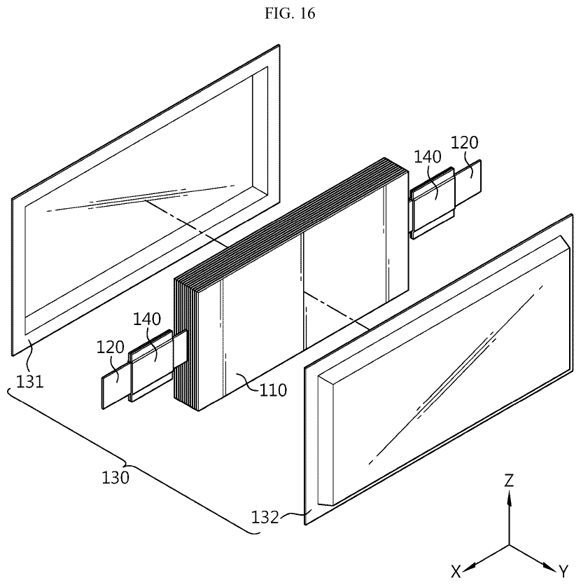

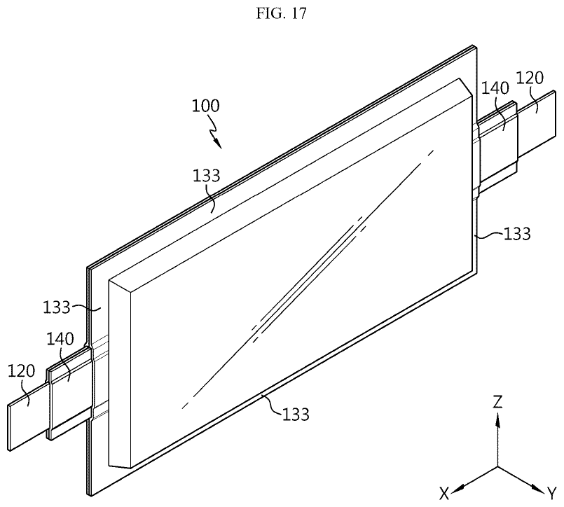

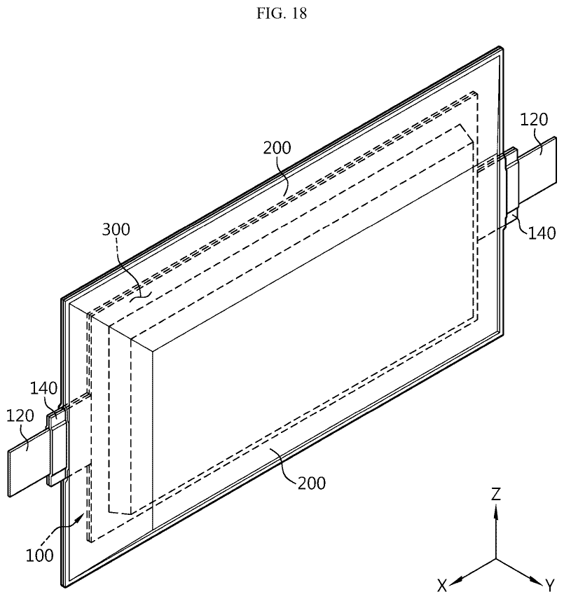

FIG. 16 is a drawing illustrating the coupling of an electrode assembly and a first case of a battery cell assembly according to another embodiment of the present disclosure. FIG. 17 is a drawing illustrating a battery cell of a battery cell assembly according to another embodiment of the present disclosure. FIG. 18 is a drawing illustrating a battery cell assembly according to another embodiment of the present disclosure. Referring to FIGS. 16 to 18, a first case 130 of a battery cell assembly according to another embodiment of the present disclosure may include a first part 131 covering one side of the electrode assembly 110 and a second part 132 covering the other side of the electrode assembly 110 and bonded to the first part 131. In addition, the second case 200 may extend to cover a portion where the first part 131 and the second part 132 are bonded. The first case 130 may be formed by attaching or bonding the first part 131 and the second part 132, which are separately provided. Therefore, a terrace portion 133 of the battery cell 100 may be formed on four surfaces along the front surface, upper surface, lower surface, and back surface of the battery cell 100. In addition, the second case 200 may form a gap along the terrace portion 133 of the battery cell 100, and the gap may be filled with an extinguishing agent 300. That is, the extinguishing agent 300 may be disposed along the front surface, upper surface, lower surface, and back surface of the battery cell 100. Alternatively, the extinguishing agent 300 may be filled to surround a portion where the first part 131 and the second part 132 are bonded. The second case 200 may be attached, coupled, or fixed to the side of the battery cell 100 or the first case 130.

According to this configuration of the present disclosure, the space occupied by the extinguishing agent 300 may be reduced. In addition, the extinguishing agent 300 may not be positioned on both sides of the battery cell assembly. As a result, when the battery cell assemblies are stacked in the left-right direction or the Y-axis direction, the energy density may be increased.

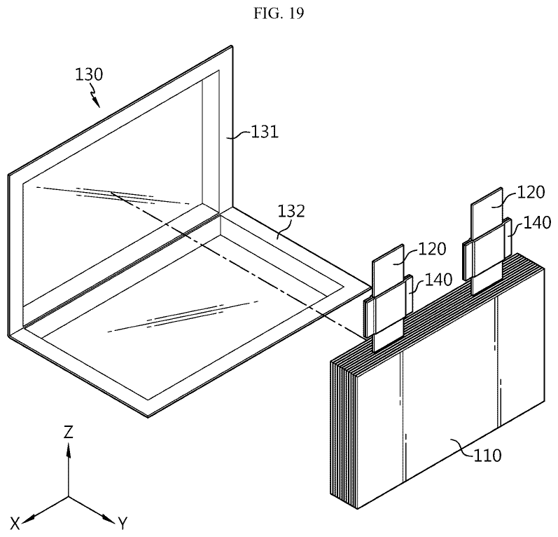

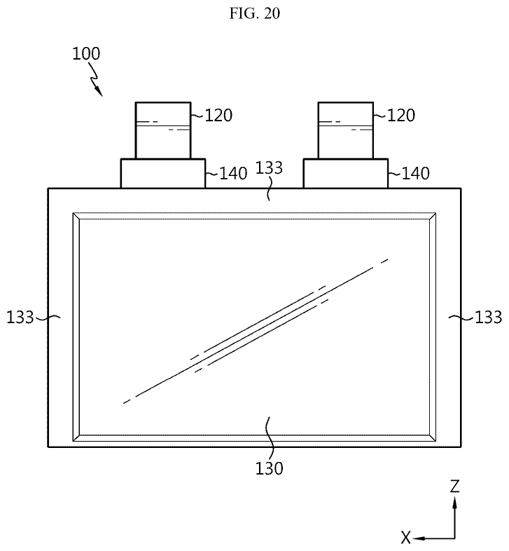

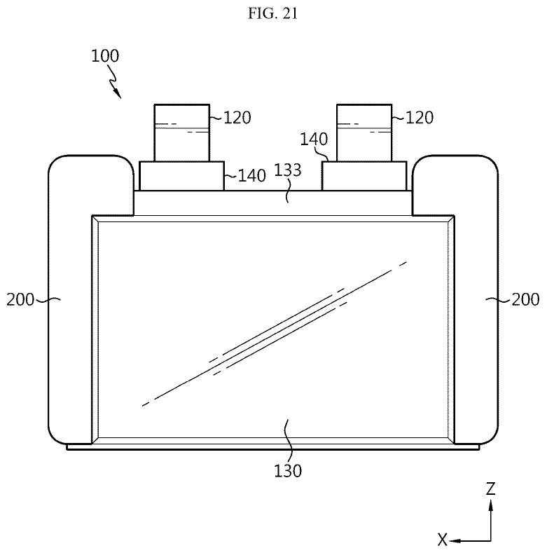

FIG. 19 is a drawing illustrating the coupling of an electrode assembly and a first case of a battery cell assembly according to another embodiment of the present disclosure. FIG. 20 is a drawing illustrating a battery cell of a battery cell assembly according to another embodiment of the present disclosure. FIG. 21 is a drawing illustrating a battery cell assembly according to another embodiment of the present disclosure.

Referring to FIGS. 19 and 21, a battery cell 100 of a battery cell assembly according to another embodiment of the present disclosure may have two electrode leads 120 protruding in the upward direction or the +Z-axis direction. A first case 130 may include a first part 131 covering one side of the electrode assembly 110 and a second part 132 covering the other side of the electrode assembly 110 and bonded to the first part 131. In addition, the second case 200 may extend to cover a portion where the first part 131 and the second part 132 are bonded. The first case 130 may form the first part 131 and the second part 132 by folding one member thereof. Therefore, the terrace portion 133 of the battery cell 100 may be formed on three surfaces along the front surface, upper surface, and back surface of the battery cell 100. In addition, the second case 200 may form a gap along the terrace portion 133 of the battery cell 100, and gap may be filled with an extinguishing agent 300. That is, the extinguishing agent 300 may be disposed along the front surface, upper surface, and back surface of the battery cell 100. Alternatively, the extinguishing agent 300 may be filled to surround a portion where the first part 131 and the second part 132 are bonded. The second case 200 may be attached, coupled, or fixed to the side of the battery cell 100 or the first case 130. In addition, the second case 200 may be configured to cover only a portion of the upper surface for electrical insulation from the electrode leads 120. For example, the second case 200 may be configured not to cover a portion adjacent to the electrode leads 120 and a portion between the two electrode leads 120.

According to this configuration of the present disclosure, the space occupied by the extinguishing agent 300 may be reduced. In addition, the extinguishing agent 300 may not be positioned on both sides of the battery cell assembly. As a result, when the battery cell assemblies are stacked in the left-right direction or the Y-axis direction, the energy density may be increased. In addition, the electrical insulation of the electrode lead 120 and the second case 200 may be improved.

A battery module according to the present disclosure may include two or more battery cell assemblies according to the present disclosure described above. In addition, the battery module according to the present disclosure may further include, in addition to the battery cell assemblies, various components such as components of the battery module known at the time of filing the present disclosure, such as a bus-bar assembly, a module case, a cooling unit, and the like.

A battery pack according to the present disclosure may further include two or more battery cell assemblies according to the present disclosure described above. In addition, the battery pack according to the present disclosure may further include, in addition to the battery cell assembly, various components such as components of the battery pack known at the time of filing the present disclosure, such as a BMS, a bus-bar, a pack case, a relay, a current sensor, and the like.

A vehicle according to the present disclosure may include two or more battery cell assemblies according to the present disclosure described above. The battery cell assembly according to the present disclosure may be applied to a vehicle such as an electric vehicle or a hybrid vehicle. In addition, the vehicle according to the present disclosure may further include various other components included in the vehicle, in addition to the battery cell assembly. For example, the vehicle according to the present disclosure may further include a car body, a motor, a control device such as an ECU (electronic control unit), and the like, in addition to the battery cell assembly according to the present disclosure.

Meanwhile, although terms indicating directions such as upward, downward, left, right, front, and back are used in this specification, it is obvious to those skilled in the art that these terms are only for convenience of explanation and may vary depending on the location of the target object or the location of the observer.

As described above, although the present disclosure has been described with reference to limited embodiments and drawings, the present disclosure is not limited thereto, and various modifications and variations are possible within the technical idea of the present disclosure and the scope of equivalence of the claims to be described below by those skilled in the art to which the present disclosure pertains.

1. A battery cell assembly comprising:
a battery cell comprising an electrode assembly and a first case configured to surround the electrode assembly;
a second case configured to cover at least a portion of the first case; and
an extinguishing agent configured to fill a space between the first case and the second case.

2. The battery cell assembly according to claim 1,
wherein the second case includes an electrically insulating material.

3. The battery cell assembly according to claim 1, wherein the second case includes a same material as a material of the first case.

4. The battery cell assembly according to claim 1,
wherein the second case is spaced apart from at least one surface of the first case to form a gap, and
wherein the gap is configured to be filled with the extinguishing agent.

5. The battery cell assembly according to claim 1,
wherein the battery cell further comprises an electrode lead configured to protrude from the electrode assembly,
wherein the first case comprises a terrace portion configured to surround the electrode lead,
wherein the second case is spaced apart from the terrace portion to form a gap, and
wherein the gap is configured to be filled with the extinguishing agent.

6. The battery cell assembly according to claim 5,
further comprising an insulating member positioned between the electrode lead and the terrace portion and configured to surround the electrode lead.

7. The battery cell assembly according to claim 6,
wherein the insulating member extends to be exposed to an outside of the terrace portion.

8. The battery cell assembly according to claim 6,
wherein the insulating member extends to be exposed to an outside of the second case.

9. The battery cell assembly according to claim 1,
wherein the first case comprises:
a first part configured to cover one a first side of the electrode assembly; and
a second part configured to cover a second side of the electrode assembly. the second part being bonded to the first part, and
wherein the second case extends to cover a portion where the first part and the second part are bonded.

10. The battery cell assembly according to claim 9,
wherein the extinguishing agent is configured to surround the portion where the first part and the second part are bonded.

11. The battery cell assembly according to claim 1,
wherein the extinguishing agent includes Novec 1230.

12. battery module comprising the battery cell assembly of claim 1.

13. A battery pack comprising the battery cell assembly of claim 1.

14. A vehicle comprising the battery cell assembly of claim 1.
